(19) United States
(12) Patent Application Publication
(10) Pub. No.: US 2026/0268283 A1
(43) Pub. Date: Sep. 10, 2026

(54) RECOMMENDER SYSTEM FOR WORKFORCE MANAGEMENT

(71) Applicant: Beamery Limited, London (GB)

(72) Inventors: Ahmad ASSAF, London (GB); Henri Egle SOROTOS, London (GB); Kaan KARAKEBEN, London (GB); Sebastian Montero PARIS, London (GB); Alisa MILCHEVSKAYA, London (GB); Vladyslav BURYLOV, London (GB); Tom JENNINGS, London (GB); Kacper PISKORSKI, Abu Dhabi (AE); Murad SAIDOV, London (GB); Pavel KILOVATIY, London (GB)

(21) Appl. No.: 19/072,902

(22) Filed: Mar. 6, 2025

(51) Int. Cl. G06Q 10/1053

(52) U.S. Cl. CPC G06Q 10/1053

(57) ABSTRACT

A system includes memory storing instructions for carrying out operations comprising receiving profile data comprising a description of an entity and processing the profile data using a machine learning model to generate, in dependence on a scheme learned from a prearranged dataset and relating the entity and a predefined set of attributes, a graph representing information derived from the description. The graph has a set of nodes comprising a first node representing the entity and second nodes each representing a respective attribute and being linked to the first node by a respective edge relating the entity to the respective attribute. The operations also comprise processing the graph using a graph neural network to generate a set of embeddings each representing a respective node of the set of nodes, and providing, to a user of the system, a recommendation in relation to the entity in dependence on the set of embeddings.

### BACKGROUND OF THE INVENTION

### Field of the Invention

The present disclosure relates to a system for providing recommendations using machine learning models. The disclosure has particular, but not exclusive, relevance to providing recommendations to users of a workforce management system.

### Description of the Related Technology

Recommender systems have myriad applications in modem industrial settings. In the context of online marketplaces, customers can be recommended sale items based on their preference data. In other contexts, such as in online search, a user can be recommended results based on previous searchers performed by the user. In many such contexts, machine learning algorithms have been used to optimize the recommendations by training on large datasets that include data for millions of customer or user queries. One important context for the application of recommender systems is Candidate Relationship Management (CRM), which is an essential component of Human Resources (HR) management. CRM tools enable recruiters to streamline the recruitment process, and recommender systems are a key to efficiency because candidate selection and recruitment is an otherwise time-consuming process. Suitable candidates must often be screened from thousands of applications, each of which may include unstructured textual data of job applicants. If implemented satisfactorily, HR recommender systems can help organizations efficiently screen and find a promising subset of potential candidates from vast amounts of data, including candidate applications as well as candidate interactions with CRM tools. Such system may help further streamline the recruitment process by prioritizing or ranking candidates within the screened dataset and may enhance the overall employer and candidate experience by ensuring that job seekers are presented with opportunities that align with their skills and career aspirations.

However, building accurate, reliable, and unbiased recommender systems in the HR domain presents several challenges. For example, developing recommender systems based on trained machine learning algorithms is challenging in the HR domain as the relevant data, for example, in the form of job descriptions (JDs), is generally unstructured, high-volume and complex. Moreover, JDs may vary in format and content across different industries, and the relative significance of the same skills may vary across different workplace settings. Due to these inherent complexities in HR data, developing HR recommender systems with broad applications to multiple industries can be challenging. Furthermore, machine learning algorithms used in recommender systems often identify patterns and base their optimal recommendations on the parameters learned based on a training dataset. This introduces additional challenges in the form of dataset bias, which is a significant hindrance to fair and unbiased recruitment. Moreover, the dynamic nature of the job market necessitates continuous updates and improvements to the recommendation models to maintain their relevance and effectiveness. The present disclosure addresses some of these and other challenges.

### SUMMARY

According to an aspect of the disclosure, there is provided a system comprising at least one processor for providing a recommendation to a user of the system. According to further aspects of the present disclosure, there is provided a computer-implemented method to provide a recommendation to a user, and one or more non-transient storage media carrying instructions for carrying out the method.

The system includes at least one memory that stores instructions for carrying out operations comprising receiving profile data comprising a description of a workforce entity and processing the profile data using a machine learning model to generate, in dependence on a scheme relating the workforce entity and the predefined set of attributes, a graph representing information derived from the description of the workforce entity. The scheme may be associated with a prearranged dataset, and the graph may have a set of nodes comprising a first node representing the workforce entity and one or more second nodes representing a respective attribute from the predefined set of attributes and being linked to the first node by an edge relating the workforce entity and the respective attribute. The operations further comprise processing the graph using a graph neural network to generate a set of embeddings each representing a respective node in the set of nodes, and providing, to a user of the system, a recommendation in relation to the workforce entity in dependence on the set of embeddings.

The machine learning model enables a graph representation of unstructured profile data to be generated based on a scheme that may describe a variety of workforce contexts. In this manner, the graph may make use of a shared vocabulary of entities, their attributes, and the interrelationships between them as resourced from the scheme. Such a graph may for the basis for a latent representation of the workforce entity that may be widely transferable across workforce contexts. By using a graph neural network to process the obtained graph, accurate latent representations in the form of embeddings may be obtained for the workforce entity and its attributes. Such embeddings can be leveraged within a variety of downstream recommendation tasks. The use of embeddings generated by the graph neural network also may also reduce bias, as defined in accordance with several different metrics, in the recommendations provided by the system.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1A schematically shows components of a user recommender system in accordance with examples.

FIG. 1B schematically shows an exemplary use case of the system of FIG. 1A.

FIG. 2 is a flow diagram showing the operations performed by the system components to provide user recommendations.

FIG. 3 is a schematic diagram showing operations performed by the system components to generate a graph for providing user recommendations.

FIG. 4 is a schematic diagram showing operations performed to generate a graph containing context nodes.

FIG. 5 is a schematic diagram representing operations performed by the system components to train the graph neural network.

### DETAILED DESCRIPTION OF CERTAIN INVENTIVE EMBODIMENTS

Details of systems and methods according to examples will become apparent from the following description with reference to the figures. In this description, for the purposes of explanation, numerous specific details of certain examples are set forth. Reference in the specification to ‘an example’ or similar language means that a feature, structure, or characteristic described in connection with the example is included in at least that one example but not necessarily in other examples. It should be further noted that certain examples are described schematically with certain features omitted and/or necessarily simplified for the ease of explanation and understanding of the concepts underlying the examples.

Embodiments of the present disclosure relate to systems and methods for generating user recommendations using machine learning models. In particular, the embodiments described herein address challenges involved in generating user recommendations based on Human Resources (HR) data in the context of candidate relationship management. A language model is configured to process profile data, which may be a job profile or a candidate profile. In particular, the profile data is processed in dependence on a knowledge graph that defines relationships between entities and attributes in HR data. In this manner, the language model is able to generate a graph that relates a given candidate to its attributes such as skills, roles, employer, etc. The graph is then processed by a graph-neural network (GNN) trained to produce one or more embeddings in a latent space. These embeddings constitute a latent representation of the one or more candidate and/or job profiles and may be used to determine similarities between the various profiles. Profiles that are similar may be recommended to a user of the system. The embeddings may also be used to generate and recommend new profiles to the user.

### System Components

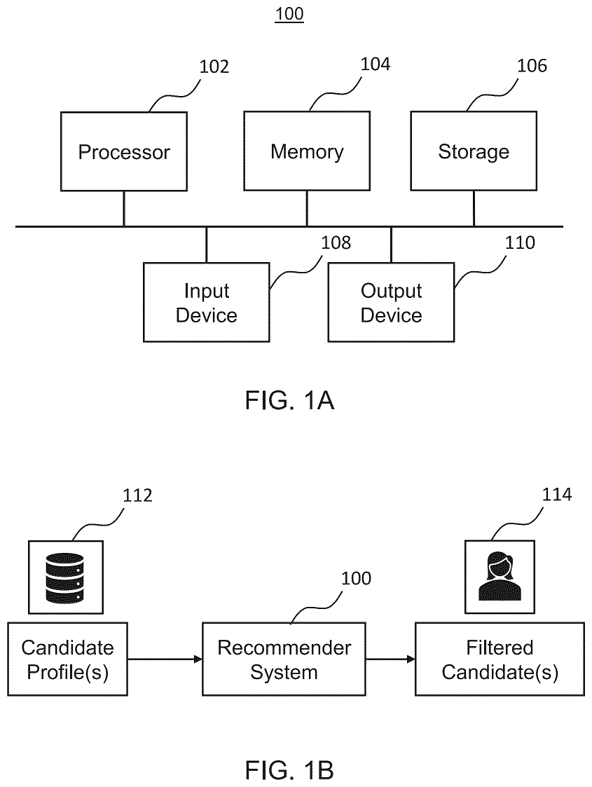

FIG. 1A schematically shows components of a user recommender system 100 in accordance with examples. The user recommender system may be a suitable computing apparatus for performing operations and/or one or more methods described herein. The system 100 may include one or more processors 102, memory 104, and data storage 106. The processor 102 may execute instructions that implement the functions and operations of the device. The processors 102 may include, for example, one or more of each of a central processing unit (CPU), a graphics processing unit (GPU), and/or a neural processing unit (NPU). Any of these processors may have multiple cores, and various parts of the pipeline described herein may be parallelized between cores and/or between processors. For example, inference and/or training steps for one or more machine learning models used by the system may be parallelized across GPU cores. The processor 102 may access memory 104 and data storage 106 (or another suitable memory region or element) to retrieve instruction or data used in executing the instructions.

The memory 104 may be volatile memory (eg. RAM) that may store program code, binaries or executables for implementing any of the functional components or modules described herein. The data storage 106 may be non-volatile memory (e.g. hard disk) for storing software programs and datasets that may be processed by the software to execute instructions described herein. Datasets may be stored in various formats and may extend to complex data structures including Knowledge Graphs. In examples, the data storage 106 may be capable of storing graph data including Resource Description Framework (RDF) graphs or Property Graphs. The data storage 210 may comprise a computer readable medium that may also comprise a number of software modules, such as a communications module, a visualization module for the purpose of presenting output data to a user. Moreover, the data storage may store application specific software modules such as Candidate Relationship Management software. The program code may be written in any suitable programming language and may make use of any software development framework such as PyTorch and/or Tensorflow. Certain subroutines may further make use of lower layer task-specific and/or hardware-specific frameworks, such as CUDA by Nvidia (RTM) or Triton by OpenAI (RTM) for model training.

The input 108 and output devices 110 may enable a user to interact with a user interface for inspecting or otherwise interacting with. The input device may be a keyboard, a mouse, a touchscreen, or another such peripheral that may enable a user to operate the system 100. The output device 106 may be configured to output data (via a screen, or a projector). In examples, the output data may include outputs such as user recommendations produced by one or more machine learning models. The output data may also include graphical output generated by visualization software stored in the data storage 106. In addition to the components described thus far, the system 100 may include components such as a power supply including a mains supply and/or a battery. Moreover, the system 100 may be a single device or may include multiple devices connected over a network. In such examples, the system 100 may further include a communications element to enable data transfer from another device or remote storage over the internet or another network. In examples, such a communications element may enable connections over wired or wireless networks with other devices. In this manner, the system 100 may be able to harness computational resources of a server device that may perform one or more operations and/or methods as described herein.

Examples described herein with reference to FIGS. 1B-5 comprise computer operations or methods performed in one or more processing systems and/or processors. However, in some examples, the disclosure also extends to computer programs, particularly computer programs on or in an apparatus, adapted for putting the disclosure into practice. The program may be in the form of non-transitory source code, object code, a code intermediate source and object code such as in partially compiled form, or in any other non-transitory form suitable for use in the implementation of processes according to the disclosure. The apparatus may be any entity or device capable of carrying the program. For example, the apparatus may comprise a storage medium, such as a solid-state drive (SSD) or other semiconductor-based RAM; a ROM, for example, a CD ROM or a semiconductor ROM; a magnetic recording medium, for example a hard disk; optical memory devices in general; etc.

### Profile Matching

FIG. 1B schematically shows an exemplary method of providing a recommendation using a recommender system such as the system 100 of FIG. 1A. The method shown provides recommendations in the context of a workforce management system. In particular, the recommender system may be used by a recruiter to match or recommend candidates for a job opening. For example, a recruiter may be seeking to find a filtered set of candidates for a given job opening. In this context, a dataset 112 containing candidate profiles may be obtained and processed by the recommender system 100. Candidate profiles may include job applications, resumes and/or any candidate specific data collected by the recruitment agency or employer. The recommender system 100 may process the dataset 112 including one or more candidate profiles to output a filtered set 114 of screened candidates.

In order to provide such a filtered set as a recommendation, the recommender system 100 may process the dataset 112 to extract information regarding skills, qualifications, competencies, and prior experiences from each of the candidate profiles. In particular, the recommender system 100 may make use of one or more software components stored in the system 100 for this purpose. For example, the recommender system 100 may make use of one or more pre-trained machine learning algorithms to process the dataset 112. By extracting candidate credentials from the candidate profiles in the dataset 112, the recommender system 100 may seek to obtain a latent representation of the candidate data in a high-dimensional vector space associated with candidate credentials. In the context of recommending a filtered set of candidates with a vacancy, the requirements of a given vacancy may be processed by the recommender system 100 analogously to the profile of an ideal candidate. In this manner, a latent representation associated with the job opening or vacancy may also be produced by the recommender system. The recommender system 100 may then compare the respective representations of candidates and the job to determine a filtered dataset 114 of candidates based on the relative pairwise similarities of the representations. The filtered dataset 114 may be provided to a user (such as recruiter) as a recommendation.

More generally, the recommender system 100 may be used for comparing any two candidates based on their latent representations obtained by processing their profiles. Besides matching candidates with a job or comparing candidates with each other, the recommender system 100 in FIG. 1B may be used in other downstream applications relevant to workforce management. For example, a recruiter may be interested in creating a new job profile from collected candidate profiles or known job profiles. In such examples, the latent representations associated with the various profiles as obtained by the recommender system 100 may be combined to produce the representation for an optimal or desired profile. Such a representation may then be transformed into a suitable description of the candidate or job profile. In this manner, the representations obtained by the recommender system 100 may be used as building blocks to create and compare candidate profiles within a workforce context. The following passages describe exemplary operations performed by the recommender system in such use cases.

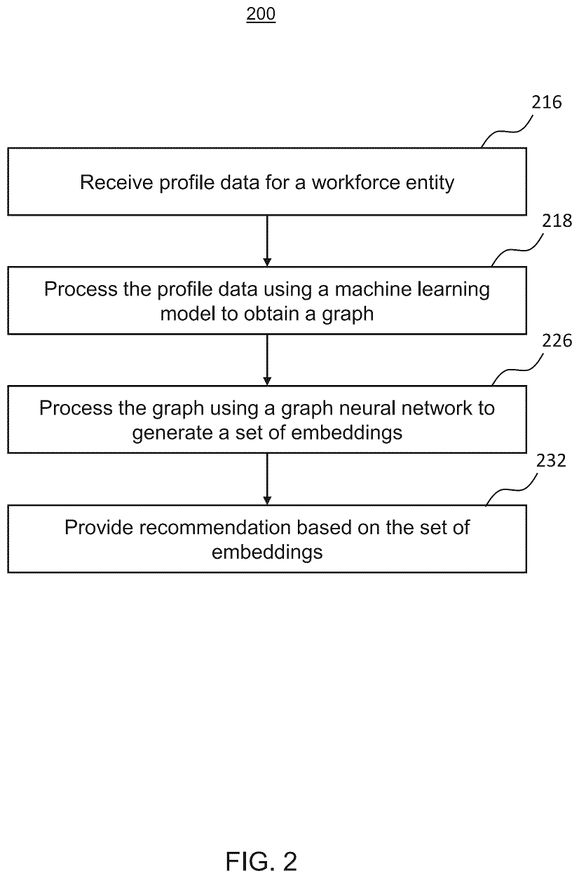

FIG. 2 is a flow diagram showing the operations performed by the system 100 to provide user recommendations. The operations comprise, at 216, receiving profile data comprising a description of a workforce entity. In examples, the workforce entity may be a candidate or an applicant for a job. In such examples, the profile data may be included in a dataset containing one or more candidate profiles. The profile data for a candidate may include a description of the candidate that may list their attributes such as past employment experience, qualifications, skills, and/or roles. In other examples, the workforce entity may be a job description of an opening or vacancy. In such examples, the description in the profile data may list attributes that are job requirements including skills, qualifications, and employment experience required for the job. In either case, whether the profile data relates to a candidate or a job profile or yet another workforce entity, the system 100 may be configured to process attributes from a predefined set of attributes including skills, roles, qualifications, employers, experiences.

The profile data may primarily include textual data and the description may be a textual description of the workforce entity. Also, the profile data may be received in any suitable format, including standard .txt or .doc or .docx formats, but in some examples, the textual data may be enriched using scripts providing syntactical information such as in the case markdown, JSON, or other formats. Moreover, the profile data may include metadata for providing contextual information about the candidate or the source of the data, such as in the form of weblinks or dataset handles. Further, the profile data may include supplementary image or audio data such as in the form of recordings by a candidate or employer. After receiving the profile data, the system 100 may carry out one or more processing operations. For example, the profile data may be processed to standardize the contents or format of the description in order to prepare the data for further processing. Contents of the description may be cropped and pruned to reduce the size of the profile data. For this purpose, the system 100 may invoke one or more applications stored in the data storage 106. The processing operations may involve the use of one or more processors 102 included in the system 100.

### Attribute Extraction and Reconciliation

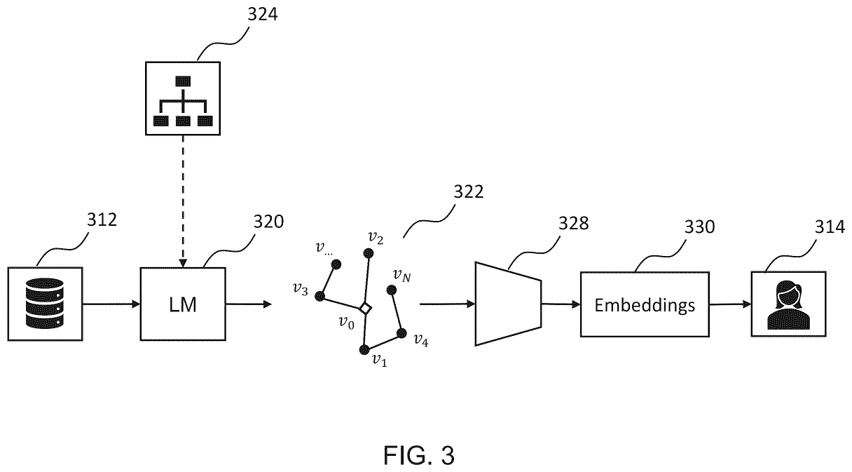

The system may subsequently carry out, at 218, processing the profile data using a machine learning model to generate a graph. In examples, the machine learning model may be a generative model, such as a generative language model capable of processing textual data associated with the profile data. Such examples may be applicable to processing descriptions in the profile data that may be in the form of natural language entities. For example, the machine learning model may be a generative Large Language Model (LLM) such as a suitable version of OpenAI's LLMs including ChatGPT-4. Other LLMs can also be used for this purpose including Anthropic's Claude models, Meta's Llama models, Granite models by IBM, and Gemini or Gemma models by Google, and Microsoft's Phi models. In other examples, the machine learning model may be a generative multi-modal model capable of processing other modalities of data such as audio, video and/or image data simultaneously with textual data. A method of training, tuning, and adapting the machine learning model to extract a graph as an output is described with reference to FIG. 3 in the passages below.

FIG. 3 is a schematic diagram showing operations performed by the system components to generate a graph for providing user recommendations. FIG. 3 shows profile data 312 being processed by a language model (LM) 320 to generate a graph 322. The language model 320 is shown in FIG. 3 as being configured to process the profile data in dependence on a scheme 324. In particular, the scheme 324 may be a scheme learned from a prearranged dataset and may relate the workforce entity and a predefined set of attributes. As an example, the prearranged dataset may contain data relating one or more workforce entities and a predefined set of attributes, and a scheme representing those relationships may be extracted from such a dataset. For example, the language model may be trained using the scheme 324 to extract attributes from a predefined set of attributes that may be present in the description or other components of the profile data 312. As an example, where the workforce entity is a specific candidate, the scheme 324 may provide relationships between a “candidate” entity and attributes such as “skills”, “roles”, “employers”, and “qualifications”. For example, the scheme 324 may relate each attribute in the predefined set of attributes as a property of the workforce entity. In this manner, the scheme 324 may provide the language model 320 with a structured lexicon against which to tabulate the specific attributes of the workforce entity within the description of the profile data 312. In examples, the scheme 324 may be tailored to specific industrial contexts using prearranged datasets corresponding to those contexts. In general, however, a broad scheme may be used based on a prearranged dataset covering diverse contexts that provides relationships between workforce entities and their attributes across a wide range of industries. Moreover, the scheme 324 may in general define relationships between the predefined attributes themselves. For example, the scheme 324 may relate skills of a candidate with roles. Such relationships may also involve intermediate attributes or workforce entities. For instance, skills may be linked to roles via an industrial sector.

In some examples, the scheme 324 may be a knowledge graph. In this context, a knowledge graph may refer to a rich database that employs a graph-structured data model (also known as a topology) to represent the data. Knowledge graphs can be used to store interlinked descriptions of data objects while simultaneously encoding relationships (in the form of an ontology) underlying the data objects. In this manner, a knowledge graph may provide access to structured information defined based on a domain-specific “ontology” (also known as a schema). As a result, knowledge graphs enable semantic interpretation and reasoning to be performed on the database and are therefore also referred to as knowledge bases. In the context of CRM, a knowledge graph may be prepared that stores information about different candidates as well as different types of candidate attributes as nodes of a graph. Candidates possessing certain attributes in the graph may be linked to the nodes representing those attributes using edges. In general, the edges may be bidirectional. For example, an edge pointing from a candidate node to an employer node may represent a relationship “employed by” signifying that the specific candidate is employed by the specific employer connected by the edge. Similarly, an edge point from the employer node to the candidate node may represent a relationship “employs” signifying that the employer employs the candidate. A query on the knowledge graph “who employs candidate X?” may only require finding an edge amongst all edges pointing from employer nodes to the node for candidate ‘X’. In this manner, a knowledge graph may provide a rich knowledge base which can be used to efficiently infer semantically meaningful “truths”. A knowledge graph may be prepared based on such an ontology a priori to prime the language model 320. For example, prearranged CRM datasets collected from many different industries may be used to prepare a knowledge graph. Moreover, the knowledge graph may be built on top of existing ontologies such as the Resource Description Framework (RDF) or the Web Ontology Language (OWL) ontologies, and may make use of organizational frameworks such as the Simple Knowledge Organization System (SKOS). In the context of workforce management, the knowledge graph may embody the hierarchical taxonomy such as prescribed by the European Skills, Competences, Qualifications, and Occupations (ESCO). In this manner, the knowledge graph may operate within a strictly controlled vocabulary that describes the domain of Human Resources (HR), and from which “truths” relating to HR data, within a given workforce context, may be extracted.

In the context of the present disclosure, a knowledge graph may be associated with a workforce context. For example, data from a set of related industries may be used in the preparation of the knowledge graph. The knowledge graph may comprise data objects as described above. For example, the knowledge graph may include a first set of data objects representing workforce entities in the workforce context. In examples, workforce entities may include candidates, jobs, vacancies, or other workforce entities. The knowledge graph may also include a second set of data objects representing attributes from the predefined set of attributes. In examples, the attributes may include skills, roles, qualifications, or other attributes. The knowledge graph may also prescribe relationships between data objects in the form of edges. For example, each data object of the first set of data objects may share a directional edge with a respective data object of the second set of data objects, each edge denoting a respective relation between the data object in the first set of data objects and the respective data object of the second set of data objects. More generally, the data objects within each set may also be connected with edges denoting relations amongst members of the set. The knowledge graph may act as a scheme 320 and may be used to prime the language model 320 to extract elements of given textual data that correspond to the prescribed ontology. Furthermore, the knowledge graph may be prepared based on a vast amount of data relating to many different industries. In this manner, the knowledge may enable the language model 320 to operate on a consolidated ontological vocabulary that is transferable between industries. As a result, the results of the recommender system 100 may span multiple industrial domains rather than being confined to a single workplace setting. In general, any scheme 324 may be used to configure the language model 320 for processing the profile data 312. Using an appropriate scheme 324 such as a knowledge graph may enable the recommender system 100 to be versatile, and therefore result in higher quality recommendation outputs.

### Graph Generation

The language model 320 may be configured to process the profile data 312 in dependence on the knowledge graph to generate an output graph 322. In particular, the graph may represent information derived from the description of the workforce entity in the profile data. In examples, the language model may be primed using prompt engineering to serve as an interlocutor between the domain of the knowledge graph and the profile data 312. In particular, the extraction of the graph from the profile data 312 may be presented to the language model 320 as a task. In examples, the language model may be trained to perform the task using machine learning approaches such as few-shot learning, or one-shot learning. In such examples, desired graph results for a few or one example profile data may be shown to the language model 320 along with the knowledge graph to prompt it to generate the graph 322 for the specific profile data 312. Further pre-training may be conducted prior to performing inference on the profile data 312, and more generally, the language model 320 may learn to perform the task over the course of processing multiple profile data(s) 312. In this manner, the language model 320 may be trained to extract attributes from the description of the profile data 312 and tabulate them against the schema embodied by the knowledge graph. Whilst the knowledge graph itself may contain a vast amount of data, represent by millions of nodes and edges, the schema itself may be represented by a small subgraph corresponding to a given workforce entity associated with the profile data 312 and its attributes. A plethora of available LLMs may be configured to process the profile data 312 in dependence on a knowledge graph. For example, SBERT is a language model described in “Reimers, N. and Gurevych, L, Sentence-BERT: Sentence Embeddings using Siamese BERT-Networks (2019), arXiv: 1908.10084”, which can be adapted for this purpose.

Upon processing the profile data 312, the result obtained by the language model 320 may take the form of a list of edges and corresponding features. The edges may each represent relationships between the workforce entity and attributes from the predefined set of attributes as embodied within the knowledge graph. In this manner, the output of the language model 320 may be seen as a graph 322 (or more specifically a subgraph of the knowledge graph) defined by the edges linking a set of nodes that include the workforce entity as a first node and the attributes of the predefined set of attributes as second nodes. FIG. 3 shows the graph 322 as comprising a first node v₀ representing the workforce entity, and second nodes v₁, v₂, v₃ representing attributes from a predefined set of three attributes. In general, a set of higher cardinality may be used, resulting in a graph with a greater number of second nodes. The edges may each represent semantic relations between the workforce entity and the respective second nodes. As mentioned previously, the edges may be bidirectional, denoting relationships from the workforce entity to the second node and vice versa.

The graph 322 may be considered as a subgraph of the knowledge graph as it includes nodes and edges in accordance with the schema encoded the knowledge graph. As such, the process of obtaining a graph 322 based on a scheme 324 such as a knowledge graph may be referred to as “reconciliation”. In examples, the information derived from the description as represented by the graph 322 may be represented by a set of features associated with the set of nodes. For example, the language model 320 may associate each attribute with a corresponding feature derived from the description in the profile data 312. Each such feature may, for example, represent a textual label or numerical extract corresponding to the profile data 312 as extracted by the language model 320 from the description. The language model 320 may extract the features by default (due to being trained to produce the features) or may be specifically prompted to do so. In examples, the node representing the workforce entity may be associated with a feature including a candidate name and/or contact details. Similarly, the nodes representing attributes such as skills may be associated with the specific skills described for the candidate in the description of the profile data 312. The resulting graph 322 may therefore be referred to as a text-attributed graph (TAG), in which nodes are associated with text attributes (node features), in the form of textual labels or descriptions. In general, the graph 322 may include nodes other than those which have analogs in the knowledge graph. FIG. 3 shows the graph 322 as including nodes v₄, v . . . , v_{N} denoting N−3 context nodes (or contextual nodes) within graph 322 comprising a total of N nodes. As an example, the language model 320 configured using the knowledge graph may be capable of listing additional nodes as a result of processing the profile data. Such additional nodes may, for example, represent attributes of attributes within the predefined set of attributes. As an example, the language model 320 may derive an “industrial sector” node and relate it using an edge with the “skill” node, which may be a predefined attribute encoded by the knowledge graph. Such additional nodes, thought not reconciled with the knowledge graph, may provide contextual constraints on the final recommendation output provided by the system 100. In particular, the additional contextual constraints may serve to improve the relevance and accuracy of the recommendations. For example, processing the graph 322 using the graph neural network (encoder 328) may comprise processing the one or more context nodes and the set of embeddings generated may comprise embeddings representing the one or more context nodes. In this manner, the embeddings generated may come to rely on the features associated with the context nodes, and the recommendation provided to the user may depend on the generated embedding associated with the context node. In this manner, the combined use of a language model 320 and the knowledge graph may result in additional advantages such as higher recommendation accuracy.

The nodes of the graph 322 may be associated with further data in addition to the features extracted by the language model 320. For example, a representation of the node type may also be concatenated with the features. Such a representation may be obtained as a “one-hot” representation denoting the type of node using a binary vector whose components represent all possible node types. In examples, the features associated with nodes of the graph 322 may be processed further to obtain a numerical representation of the features. For example, a machine learning model such as the language model 320 may be used to process the features (that may represent textual labels) to obtain embeddings corresponding to the features. In some examples, the machine learning model may be different from the language model 320. In either context, an embedding may be a real-valued vector output of the machine learning model that may serve as a numerical representation of the corresponding input in a normed vector space. For example, where the machine learning model comprises a neural network, the embedding for a node feature may be the corresponding values of a layer of the neural network. Many different types of machine learning models may be used for producing the numerical representation of each of the node features. The language model 320 may itself be used, and an alternative language model such as the MPNet model as described in “Sun, X., Tan, X., Qin, T., Lu, J., Liu, T.-Y., MPNET: Masked and Permuted Pre-training for Language Understanding (2020), arXiv:2004.09297” may be fine-tuned and/or adopted for this purpose. The embeddings produced in this manner may be referred to as text embeddings. Further processing carried out on the graph 322 may rely on the nodes and edges of the graph 322 together with either the features of the graph 322, which may be either textual labels or text embeddings. In either case, the graph 322 may be considered a text-attributed graph which may be defined by the graph topology (including nodes and edges) and the node features, together. The graph 322 may be subsequently used to generate recommendations as described in the passages below.

### Embedding Generation

FIG. 2 shows further operations that may be carried out by the system 100 after generating the graph 322. The operation, at 226, comprises processing the graph 322 using a graph neural network to generate a set of embeddings. In this context, a graph neural network may be an artificial neural network capable of processing graphs as inputs. The architecture of a graph neural network may enable topological information of an input graph to be encoded into a numerical output, such as an embedding. In particular, the encoder of a pre-trained graph neural network may be used to process the graph 322 and compute the set of embeddings. Such an encoder may be referred to as a graph neighborhood encoder, or a node neighborhood encoder (NNE). As mentioned before, the topological information of the graph 322 may by represented by the edges connecting its nodes. In examples, the directionality of the edges may be omitted prior to providing the graph 322 as an input to the graph neural network. In other examples, the bidirectional edges of the graph 322 may be input without omitting the directionality. In either case, the graph neural network may compute an embedding for one or more nodes based on respective neighboring nodes, i.e. those nodes that are connected to a given node with an edge. Pre-computed features or embeddings associated with each neighboring node may be used for this calculation. The resulting embedding may serve as a numerical representation of the node given its interrelationships with its neighboring nodes. In examples, the embedding may be a real-valued vector in a vector space, such that different embeddings may be compared and/or combined according to the rules of vector algebra. In this manner, a graph neural network may process the graph 322 to obtain a set of embeddings corresponding to one or more nodes of the graph 322.

Several kinds of graph neural networks may be adapted for the purpose of processing the graph 322 as described above. For example, either a homogeneous or a heterogeneous graph neural network may be used. In a homogeneous graph neural network, the method of processing neighborhood information at each node may be the same across the entire graph, whereas in heterogeneous graph neural networks, each neighborhood may be processed to obtain an embedding based on a different process/calculation. As an example, the graph 322 comprises nodes that represent a workforce entity and nodes that represent attributes. A heterogeneous graph neural network may be applied to calculate embeddings for the entity-type nodes differently from the method of calculating embeddings for attribute-type nodes. It has been found by the inventors that a homogeneous graph neural network exhibits improved performance over a heterogeneous graph neural network for computing similarities between output node embeddings for the purpose of providing user recommendations. Moreover, the architecture of the graph neural network encoder may be customized for the application. For example, an architecture composed of three serially connected network blocks such as a “pre-process, graph neural network, post-process” architecture may be adopted. In such examples, the individual blocks may include different numbers of network layers, and the overall model dimensionality may be defined by specifying the dimensions of layers within each block.

The graph neural network may be pre-trained to process the graph 322. Briefly, training methods may employ training datasets or training graphs for training the encoder to generate optimal embeddings for the nodes of the graph 322. In particular, the output embeddings may be generated in a similar contextual space as that associated with the graph. The set of embeddings may be generated based on processing the features (either textual labels or text embeddings) associated with the nodes of the graph 322. In this manner, nodes representing candidates or jobs and their attributes may be provided with a latent representation in the same space as nodes belonging to a training graph, which may be obtained from a training dataset associated with a specific workforce context. In this manner, candidates associated with the profile data 312 may be compared against other candidates in a training dataset; alternatively, the attributes (such as skills) of a candidate associated with the profile data 312 may be contextualized in comparison with other attributes in the training dataset. Such training datasets may contain vast amounts of data from many different industrial contexts, thereby allowing the generating embeddings to be transferable between different industries. An exemplary method of training the graph neural network for the present purpose is described further below. Training may result in the encoder of the graph neural network being configured to process the graph 322. Once trained, the encoder of the graph neural network may be used as a standalone component to process the graph 322 and generate a set of embeddings. FIG. 3 shows the graph 322 being processed by an encoder 328 of the graph neural network. In this example, the encoder is a node neighborhood encoder of a per-trained graph neural network. The encoder 328 processes the graph 322 and produces a set of embeddings 330. In examples, the encoder 328 may process a subgraph of the graph 322. For example, the encoder 328 may process the first node v₀ representing the workforce entity (such as candidate) and a second node such as v₃ that may represent an attribute (such as skill or role). In this manner, a subset of the attributes may be processed by the encoder 328 to generate the embeddings 330. Regardless of the size of the graph 322 processed by the encoder 328, the graph neural network enables generation of representations of the nodes of the graph in a “latent” vector space that help compare contextualize a workforce entity and its attributes. As mentioned previously, the language model 320 configured using a knowledge graph may provide the recommender system 100 with a versatility to operate on different types of data including unstructured and multi-modal data. For this reason and due to its additional ability to train on vast amounts of data, the combination of the language model 320, the knowledge graph 324 and the graph neural network encoder 320 may be referred to as a Foundation Model. Due to its use in the workforce context, in the following passages, the combination of these components in the recommender system 100 may be referred to as a Talent Graph Foundation Model (TGFM).

The inventors have found that the use of a TGFM results in improved representations of the various nodes and attributes in a graph as compared with other models used for the same purpose. For example, the quality of embeddings produced by the TGFM (i.e. by the encoder 328 by processing the graph 322 produced using the language model 320) may be determined in comparison to ground-truth data, which may be in the form of a dataset containing a large number of nodes representing workforce entities from different industries with manually annotated ground truth labels. The assessments were made by the inventors under three different categories. In the first category termed Entity Similarity (ES), two different categories of assessments were made. In one subcategory (ES-acc), assessments focused on the ability of the embeddings 330 generated by the encoder 328 to detect similarities between attributes for a given candidate profile data 312 compared with the similarities present in ground truth data. In particular, embeddings generated for different nodes representing a “skill” attribute in the graph 322 were compared as part of a binary classification problem to discern whether pairs of nodes were determined to be similar or dissimilar by the embeddings. For this purpose, the embedding for a given skill node may be represented as a skill vector and may be compared with the skill vector for another skill node using cosine similarity. The accuracy of the classification (similar or dissimilar) assigned based on the embeddings could then be determined by comparing with the classification in a ground truth database. In particular, the accuracy was quantified as a best accuracy metric (“acc”) based on a ratio of correct classifications over the total number of classifications at a fixed classification threshold. In addition to the best accuracy metric, a second sub-category (ES-roc) involved using the Receiver Operating Characteristic (ROC) area-under-the-curve (AUC) metric for evaluating the accuracy across all classification thresholds. Similarly, accuracy comparisons were made for “role” attributes. A second category of assessment involved Concept Categorisation (CC), in which the generated embeddings were evaluated against pre-defined clusters such as “subsectors” with which a set of attributes may be associated. For example, a number of “skill” attributes (e.g. “editing”, “political research”, “opinion writing”) may be associated with a single “subsector” (e.g. “political journalism”). In this respect, the ground truth dataset provides the attributes such as “skills” and “roles” together with their ground truth groupings into the pre-defined clusters. The effectiveness of the clustering was evaluated using the silhouette metric, which measures the cohesion and separation of the clusters. Finally, a third category of assessment terms Outlier Detection (OD) involved clustering subgroups of entities to identify anomalies. In particular, the ability of embeddings to encode sufficient information as to group similar attributes together while isolating outliers was tested by this assessment. A purity metric was used to evaluate the effectiveness of this grouping by measuring the proportion of the largest class in each cluster. Table 1 shows the results of the evaluations for the embedding representations conducted using the four different assessments against three existing language embedding models, including closed-source models OpenAI-ADA and OpenAI-small and open-source model MPNet-base-v2. The evaluations show that the TGFM performs better than the existing language models under all assessments.

TABLE 1
Embedding representation evaluation

| | Model | ES-acc | ES-roc | CC | OD |
|---|---|---|---|---|---|
| Roles | TGFM | 0.962 | 0.959 | 0.180 | 0.964 |
| | openai-ada | 0.924 | 0.925 | 0.048 | 0.952 |
| | openai-small | 0.835 | 0.805 | 0.074 | 0.958 |
| | mpnet | 0.869 | 0.846 | 0.053 | 0.946 |
| Skills | TGFM | 0.946 | 0.945 | 0.077 | 0.905 |
| | openai-ada | 0.822 | 0.818 | 0.038 | 0.923 |
| | openai-small | 0.582 | 0.572 | 0.038 | 0.908 |
| | mpnet | 0.602 | 0.592 | 0.046 | 0.913 |

In this manner, the combined use of a language model 320 that is configured based on a scheme 324 (such as a knowledge graph) and a graph neural network encoder 328 may result in more accurate latent representations of the profile data 312. These latent representations may form the basis of providing user recommendations as described in the following passages.

### User Recommendation

FIG. 2 shows that the system 100 can further carry out, at 232, an operation comprising providing, to a user of the system, a recommendation in relation to the workforce entity in dependence on the set of embeddings. In general, a number of downstream recommendation tasks are possible. In some examples, one or more embeddings for the attributes may be used to provide recommendations as regards the suitability of a candidate in various workplace settings. For example, the embeddings 330 generated by the encoder 328 may enable attributes to be grouped; several “skill” attributes may be grouped in association with a “subsector”. In such examples, a candidate associated with the profile data 312 may be recommended for one or more subsectors with which their skills are determined as being associated by the embeddings. In other examples, the profile data 312 may correspond to a job profile (i.e. the profile of an ideal candidate). In such examples, the groupings of various attributes may be used to determine a recommendation for various sectors or industries in which suitable candidates may be found. This may be possible because the embeddings for the attributes may be grouped into clusters of similar attributes associated with a sector or an industry. In this manner, an appropriate recommendation may be provided to a user of the system 100. In some examples, the modular nature of the embeddings 330 generated by the encoder 328 may be harnessed to combine and create new embedding groups. For example, the set of embeddings 300 may be a first set of embeddings and one or more of the set of embeddings 330 may be combined (e.g. grouped or arranged) to create a composite second set of embeddings for the workforce entity. The recommendation to the user of the system 100 may then be provided based on the second set of embeddings. Such a workforce entity may therefore be associated with attributes corresponding to the grouped embeddings. In this manner, the set of embeddings 330 may provide a template from which to select attributes in a latent space, that may be combined to form embeddings for fictional workforce entities that are associated with the selected attributes. For example, the resulting workforce entities may be served or recommended as ideal or plausible candidates for a job or vacancy. In this manner, the recommender system 100 may be capable of providing new candidate recommendations to users by accurately representing attributes of an existing candidate described by the profile data 312. FIG. 3 shows such a candidate profile 314 being recommended by the system 100.

The profile data 312 considered thus far related to a single workforce entity. However, in general, multiple profile data may be processed by the system 100. In such examples, the profile data 312 may be a first profile data and the workforce entity may be a first workforce entity. Thus, the description in the profile data may be a first description of the first workforce entity. The graph 322 produced by the language model 320 may be a first graph comprising a first set of nodes. Where multiple profile data are processed by the system 100, the operations of the system 100 may further comprise receiving a dataset associated with a workforce context. For example, a pre-prepared context dataset containing data associated with candidates or employees from one or more industries may be used for this purpose. In particular, the dataset may include at least a second profile data comprising a second description of a second workforce entity. The second profile data may correspond to a candidate profile for a different candidate. The language model 320 may be configured using a scheme 324 as described previously. When processing multiple profile data, the scheme 324 may further prescribe relationships between the second workforce entity to the set of predefined attributes. For example, a second candidate may also be associated with skill, role, and qualification attributes, as in the case of the first candidate. In general, a large dataset may be used containing many different profile data for different candidates, and may include the profile data for an ideal candidate prescribed by a user of the system 100. Similarly to the processing of the profile data 312 by the language model 320, the dataset may be processed by the machine learning model to obtain a second (context) graph, which may include at least a second set of nodes that may comprise a third node representing the second workforce entity. The second set of nodes may also comprise one or more fourth nodes representing attributes from the predefined set of attributes such that the fourth nodes may each be connected to the third node by edges representing relationships between the second workforce entity and the predefined set of attributes. Finally, the nodes of the context graph may also each be associated with respective features derived from the second description of the second workforce entity. In this manner, a large graph may be obtained containing nodes for multiple workforce entities, each connected by edges to nodes representing various predefined attributes. Some of the workforce entities may be connected to a node representing the same predefined attribute. The context graph thus generated may represent relationships between one or more workforce entities within a given industrial or sectorial context. In general, however, the context graph may span multiple industries. The system 100 may be capable of further carrying out an operation comprising merging the graph 322 for the first workforce entity with the second context graph to obtain a merged graph. The merged graph may then be processed using the graph neural network to generate a second set of embeddings each representing a respective node of the merged graph. A recommendation may then be provided to a user in dependence on the second set of embeddings. In this manner, the merged graph may enable the profile data 312 for the first workforce entity to be contextualized with workforce entities and their attributes from a given workforce context.

In examples, the graph processed by the encoder 328 may be a subgraph of the merged graph including the first node representing the first workforce entity, and at least one merged node of the merged graph wherein the merged node may be obtained by performing a matching between a given one of the second nodes and a corresponding one of the fourth nodes. For example, a merged node may represent a second node that represents a same attribute as a corresponding fourth node. By processing the subgraph of the merged graph, a set of embeddings 330 may be generated in a manner akin to the processing of the graph 322 for the profile data 312. The generated embeddings may be used to provide a recommendation 314 to a user of the system 100 as described previously. In other examples, the encoder 328 of the graph neural network may be configured to process the merged graph to generate a second set of embeddings 330. Using a subgraph, may reduce the computational resources required for producing the set of embeddings 330 whilst ensuring that the embeddings relevant for any recommendations are obtained. In general, whether the merged graph or a subgraph thereof is processed, thee second set of embeddings 330 may then represent each of the first and second workforce entities together with their respective attribute node embeddings in the same latent space. This may enable comparisons to be made between the workforce entities. For example, a similarity between the first workforce entity and the second workforce entity may be determined using the second set of embeddings 330, and the recommendation may be provided based at least in part on the determined similarity. In some examples, a first embedding associated with the first workforce entity may be obtained and a second embedding associated with the second workforce entity may be obtained from the second set of embeddings 330. For example, the first embedding may be the embedding obtained for the first node or may be an embedding obtained for an attribute node associated with the first node. Likewise, the second embedding may either be the embedding for the third node or one of its attribute nodes. Regardless of the embedding chosen, the embeddings may represent similar entities such as either the workforce entity or a given attribute from the predefined set of attributes. As mentioned before, the embeddings may be real-valued vectors in a latent vector space of the same dimensions, and therefore the first and second embeddings may be compared with each other. In such examples, a similarity may be determined between the first embedding and the second embedding by comparing the real-valued vectors. As an example, a cosine similarity metric may be used to determine the similarity between the first and second embeddings. In this manner, a similarity between the first workforce entity and the second workforce entity may be determined.

The user of the system 100 may be provided a recommendation based on the similarity determined using the set of embeddings 330. For example, a potential candidate for a job may be a first workforce entity and may be compared with at least a second known or employed workforce entity from a given workforce context. The similarity of the potential candidate with the employed candidate may be used to determine the suitability of the potential candidate for a role within the given workforce context. In this manner, an appropriate recommendation may be provided to a user of the system such as a recruitment agency. Similarly, the two workforce entities being compared may be a job or an employee within a company or industry and a lower level employee within the same industry or company. By comparing the attributes thereof, the lower level employee may be provided with recommendations as to career progression. For example, dissimilarities in skills between the two employees may be used to recommend skill groups that the lower level employee may develop in order to seek a role comparable to the higher level employee. In other examples, the second workforce entity may be an ideal candidate and the corresponding second profile data may describe the characteristics and/or attributes of the ideal candidate for a given workforce context. A potential candidate such as an applicant for the job may be associated with the first profile data. The embedding associated with the applicant may then be compared with the embedding associated with the vacancy to determine a similarity of the applicant to the job requirements, and an appropriate recommendation may be provided to the user of the system. In some cases, a threshold similarity may be determined to filter candidates by iteratively operating on multiple profiles to generate respective embeddings and comparing the embeddings with the embedding for a vacancy. In this manner, the system may enable candidates to be screened for a vacancy. By relying on a scheme such as a knowledge graph, the candidate profiles may be contextualized within a large knowledge base based on which the scheme may be prepared in advance of the inference. In this manner, the resulting embeddings may be transferable across various industries such that users such as recruiters may be able to transmit their recommendations to employers in different industries. By processing the graphs associated with workforce entities using a graph neural network trained in conjunction with a language model, the system may be able to accurately represent the workforce entities and their attributes in a latent space, enabling accurate comparisons between workforce entities. In general, other different types of entity to entity comparisons are possible: any two jobs may be compared by determining similarities between the embeddings for the respective profiles, two candidates may be compared amongst each other. Thus, the recommender system 100 enables accurate comparisons to be made in a variety of downstream use cases, lending the system the requisite versatility of a foundation model.

TABLE 2
Profile-to-vacancy matching evaluation

| Model | Recall@3 | Recall@5 | Recall@10 | Recall@15 |
|---|---|---|---|---|
| TGFM | 0.500 | 0.628 | 0.823 | 0.929 |
| openai-ada | 0.469 | 0.561 | 0.638 | 0.6598 |
| openai-small | 0.474 | 0.559 | 0.637 | 0.659 |
| mpnet | 0.465 | 0.558 | 0.637 | 0.659 |

The inventors have found that the ability of the TGFM (i.e the encoder 328 used in conjunction with the language model 320) to match candidate profiles to vacancies is improved in comparison to existing language models. In order to evaluate the effectiveness of the TGFM, several profile matching tasks were given to the TGFM with the results in each task being compared to a ground truth dataset constructed from historical vacancy and candidate data. For a given vacancy in the ground truth dataset, candidates that reached a certain stage of recruitment such as those that were shortlisted and reached an interview stage were regarded as positive samples of suitable candidates. The Recall@K metric denotes the quality of prediction based on the generated embeddings for K identified candidates from a sample of N candidates per vacancy. Table 2 lists the evaluations for a number of different values of K as obtained for the TGFM against existing language models compared previously for entity evaluations. The table clearly suggests that the TGFM performs better than existing models for all recall values. Thus, the TGFM provides an accurate and effective method of recommending candidates or jobs to a user of the recommender system 100. Moreover, the inventors have found that the use of the TGFM leads to reduction of bias in entity to entity recommendations, such as candidate recommendations for a vacancy. In particular, gender and race bias in the recommendations can be reduced by using the TGFM as described above. The inventors have found that bias reduction is achieved under several different metrics, including parity, α-parity, f+ and f− parity, as well as fairness.

### Skill Inference and Aggregation

In examples, the system 100 may be used to infer additional attributes for a given candidate based on other attributes for which the embeddings 300 have been generated. For example, “skill” attributes for a given workforce entity may be inferred based on a node embedding representing “qualifications”. Such a scenario may occur as the description in the profile data 312 may not always describe skills of a candidate. In the context of HR, the candidate profile data 312 is often incomplete and therefore there may be a need to infer attributes of the candidate that have not been described in the profile data 312. The ability of a recommender system 100 to infer such missing attributes may therefore be useful in recruitment or other workforce management contexts. The inventors have found that the TGFM performs well in a skill inference task, which evaluates the ability of the TGFM to generalize information regarding skills from candidate information. In particular, a pool of N candidates is selected from M industries, and for each candidate, N skills are randomly sampled. The accuracy with which the encoder 328 produces embeddings for all declared skills is then measured. Table 3 shows the performance of the TGFM against the Recall@K metric which indicates the accuracy of recalling declared skills from amongst K recommended skills. The evaluations indicate that TGFM performs better than standalone language models for Recall@K metrics with K=50, and 100.

TABLE 3
Skill inference evaluation

| Model | Recall@20 | Recall@50 | Recall@100 |
|---|---|---|---|
| TGFM | 0.041 | 0.080 | 0.128 |
| openai-ada | 0.045 | 0.073 | 0.102 |
| openai-small | 0.039 | 0.060 | 0.085 |
| mpnet | 0.038 | 0.060 | 0.083 |

As described previously, embeddings associated with a workforce entity may be compared with embeddings associated with another workforce entity to rank candidates for a job. As an example, the embeddings associated with nodes representing skills, either inferred or obtained by direct reconciliation, may be used for the comparisons. In some examples, the first node associated with a first workforce entity may be linked to a plurality of second nodes representing a first predefined attribute. As an example, the first node in the graph 322 may represent a potential candidate, and may be linked via edges to multiple nodes representing skills. Similarly, the third node in the merged graph 322 may represent a vacancy/another candidate any may be linked to fourth nodes representing attributes such as skills possessed by the candidate or required by the vacancy. As described previously, the comparisons between the potential candidate and vacancy/another candidate may involve comparing a first embedding associated with the potential candidate and a second embedding associated with the second workforce entity. In such examples, the first embedding may be obtained by combining a plurality of embeddings associated with a plurality of second nodes linked to the first node that together represent a first attribute such as skill from the predefined set of attributes. In other examples, the second embedding may also be obtained by combining the respective embeddings associated with fourth nodes associated with skill nodes for the second workforce entity. Since the embeddings for each node representing skills may be represented as a real-valued vector in a vector space, these embeddings may be combined using vector operations to obtain an overall skill vector based on which comparisons may be made. For example, an aggregate skill vector may be obtained by aggregating individual skill vectors associated with different nodes representing skills for the potential candidate. Similarly, the skill vectors for the second workforce entity such as vacancy/another candidate may be obtained. Subsequently, the aggregated skill vectors may be compared to match potential candidates with a vacancy or to rank different potential candidates. In some examples, the individual skill vectors may be combined using an averaging operation. The averaging may involve taking a weighted average to obtain an aggregate skill vector representative of a centroid of a cluster of skills. Other combinations may be possible. In other examples, the same procedure may be used to compare an attribute other than skill between two workforce entities.

The inventors have found that obtaining an aggregate skill vector by using a standard averaging operation, or by simply adding individual skill vectors, may at times disadvantage overskilled candidates. For example, candidates having skills in addition to the skills required for a given vacancy may be found to have a lower similarity with the skill vector for the ideal candidate profile. In order to mitigate such effects, the inventors have found that different aggregation techniques may be used that do not rely on simple averaging or addition operations. For example, the individual skill vectors may be transformed using matrix transforms (in a manner akin to Principal Component Analysis (PCA)) into a latent space whose dimensions represent knowledge levels in principal knowledge areas. Subsequently, the transformed skill vectors representing knowledge levels in principal knowledge areas may be combined based on a pairwise maximum function such that the aggregate vector V of two individual transformed skill vectors V₁ and V₂ may be obtained as Vᵢ=max(V_{1,i}, V_{2,j}) where i is an index denoting the vector components. In this manner, the vectors corresponding to higher levels of knowledge in principal knowledge areas may be prioritized. The similarity of aggregated skill vectors for a potential candidate and a vacancy may then be compared. For this purpose, a function that relies upon the ratio of the knowledge level of the potential candidate and the vacancy in each dimension may be averaged to obtain a similarity coefficient, instead of using a standard cosine similarity. In this manner, a score for each candidate may be computed by comparing the aggregate skill vectors of the candidate and the vacancy, and the candidates with high scores may be screened for further assessment.

The inventors have advanced another technique to mitigate the negative effects on candidate scores for overskilled candidates. In this example, the technique may rely on first calculating a contribution to the candidate score from skills that align with the skills required for a vacancy. Various methods may be used to calculate the aligned skill score. For example, a cosine similarity between skill vectors (or the aggregate skill vector) associated with the vacancy and the skill vectors (or the aggregate skill vector) for the candidate may be used to compute the aligned skill contribution. In other examples, a probability of suitability of the candidate for the skill may be calculated based on a function depending on the skills of the candidate and the vacancy. For example, the individual skill vector for the vacancy may be used to compute a skill energy requirement V for each skill, and the individual skill vector for a candidate may be used to compute a skill energy availability E for the candidate for each skill. The skill energy requirement V and the skill energy availability E may be combined to calculate the probability of suitability P=Ce^{-f(V-E)} for given skill where C is a linear proportionality coefficient f is a function of the difference between the skill energy requirement and the skill energy availability. In examples, the function may be a square root function. Having calculated the probability of suitability a weighted average, may be computed across all overlapping skills between the candidate and the vacancy. In this manner, a contribution to the aligned skill score may be computed. In order to mitigate the negative effects of additional skills to the candidate's score, an excess skill score may be computed for skills possessed by the candidate that do not align or overlap with the skills of the vacancy. In some examples, the excess contribution may be calculated as the average of the sum of squares of individual skill vector components of the candidate. In this manner, a total score may be calculated by combining the align skill contribution and the excess skill contribution. This may allow candidates possessing skills other than those mandated by a vacancy to nevertheless score highly in the comparisons and thereby mitigate negative effects on their rank. Such alterations to the method of combining workforce entities may provide further applicability, robustness, accuracy and fairness to the recommendations provided by the system 100.

### Capability Generation

As described previously, the nodes of the graph 322 may include context nodes in addition to the one or more second nodes representing attributes from the predefined set of attributes. In some examples, the context nodes may represent contextual attributes of workforce entities that may not be captured by the scheme 324. Such contextual attributes may exist in conjunction with attributes of the predefined set of attributes, such as “skills” and “roles”. As an example, the inventors have found that extracting “capabilities” of a candidate from the profile data 322 may be useful for several downstream recommendation tasks in the present context. In such examples, a capability may denote an abstracted attribute of a candidate representing the sum of skills required for a role. Contextual attributes such as “capabilities” may represent a layer of abstraction between the attributes of “skills” and “roles” for a candidate. Similarly, a contextual attribute such as “responsibility” may be used to prescribe context nodes in the graph 322. The use of such contextual attributes that abstract away from standard skill sets may mitigate negative effects such as biases in the recommendation process.

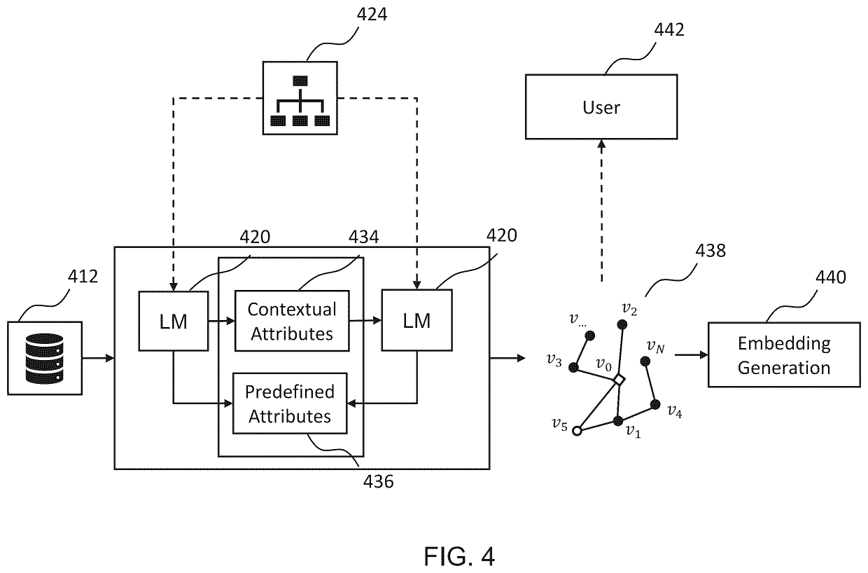

FIG. 4 is a schematic diagram showing operations performed to generate a graph containing context nodes. As shown in FIG. 4, the profile data 412 may be processed by a language model 420 configured using the scheme 424, such as a knowledge graph. However, as opposed to the previously described method of extracting a graph 322 from the language model 420, the operations involve iterated use of the language model 420 to generate a graph 438 which includes the context nodes. In particular, the language model 420 is prompted to extract both attributes 436 from the predefined set of attributes as well as contextual attributes 434. However, the first iteration of processing the profile data 412 using the language model 420 may only result in a graph 322 with connections between the first node representing the workforce entity and the second nodes representing the attributes of the predefined set of attributes; additionally, a number of unconnected nodes representing contextual attributes 434 may be generated. Each of the nodes may be associated with features derived from the description in the profile data 412. In order to extract connections between the nodes representing contextual attributes 434 and the remaining nodes of the graph, the method involves a second iteration of processing the features associated with the nodes representing contextual attributes 434 using the language model 420 by prompting the language model 420 to generate attributes from the predefined set of attributes 436 based on these features. By doing so, the language model 420 may infer connections in the form of edges between the nodes representing contextual attributes 434 and the nodes representing predefined attributes 436. In this manner, a graph 438 may be generated containing a node v₅ representing a contextual attribute such as “capability”. The graph 438 may then be used for embedding generation as described previously. Alternatively, the graph 438 or at least some of its nodes may be provided to a user of the system 100. In particular, features in the form of textual labels derived for the contextual nodes may be presented to a user. These textual labels may describe the contextual attributes of a candidate which may allow the user to directly make inferences about the candidate. Similarly, contextual attributes required for a job or a vacancy may be extracted from the job profile using the language model 420. The method of generating the graph 438 is as described in “Karakeben, K., Sorotos, H. E., Assaf, A., Rapid Graph Generation from Job Descriptions: Combining Taxonomies and LLMs (2025) The Semantic Web: ESWC 2024 Satellite Events.” However, other methods of extracting contextual nodes may be adopted. Regardless of the method of extracting nodes representing contextual attributes, the graph 438 may provide further constraints to the graph neural network to thereby improve the accuracy of recommendations.

### Training

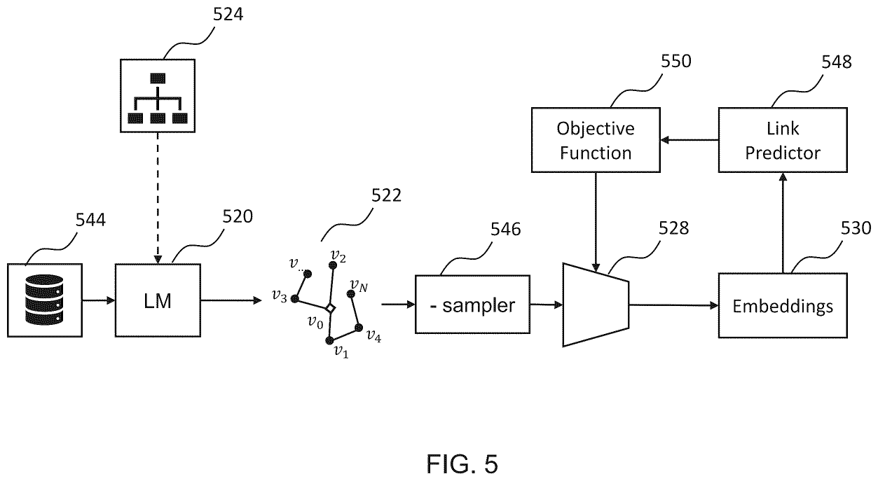

FIG. 5 is a schematic diagram representing operations performed by the system components to train the graph neural network. FIG. 5 shows a training dataset 544 being processed by the language model 520. The training dataset 544 may include profile data for multiple candidates collected from third-party providers. For example, the profile data 312 may be part of the training dataset such that the profile data may be a first profile data. In examples, the dataset 544 may include at least a second profile data comprising a second description of a second workforce entity. The training dataset 544 may include profile data for multiple candidates collected from third-party providers. FIG. 5 shows that the training dataset 544 is processed by the language model 520 to obtain a training graph 522. The training graph 522 may include a set of nodes for each profile data included in the training dataset 544. For example, the training graph 522 may include a first set of nodes associated with a first profile data and a second set of nodes associated with the second profile data. The training graph 522 may be obtained from the dataset 544 by processing each profile data using the language model 520 as described previously. Training the graph neural network may comprise a series of iterations over which the parameters of the encoder 528 are updated. In particular, training the graph neural network may involve solving a self-supervision task as described in “Wang, Z., Zhou, Y., Hong, L., Zou, Y., Su, H., Chen, S., Pairwise Learning for Neural Link Prediction (2022) arxiv.2112.02936”. For the purpose of training the graph neural network, the directionalities of the edges obtained in the graph may be omitted. Once an undirected graph is obtained, a series of training iterations may be performed as described below.

Each training iteration may involve selecting a training node from the set of nodes of the training graph 522. Subsequently, edges existing in the training graph 522 involving the training node may be identified. Such an existing set of edges may be considered as being part of a positive sample of edges. FIG. 5 shows a negative sampler 546 being used to generate a negative sample of edges. Edges belonging to the negative sample may be generated solely by the sample 546 and may not exist in the training graph 522, i.e. they may be considered to form part of a virtual set of edges. A subgraph comprising the training node and one or more nodes from the positive and negative samples of edges may then be determined. The subgraph may be processed by an encoder 528 of the graph neural network to produce a set of training embeddings 530. In particular, the encoder 528 may be a node neighborhood encoder as described previously. As an example, the encoder 528 may include a graph attention block. The embeddings in the set of training embeddings 530 may correspond to the nodes included in the subgraph, i.e. those nodes that are connected to the training node by either an edge from either the positive or the negative sample of edges. Subsequently, a link predictor 548 may be used to identify, for each edge, whether the edge was selected from the positive or the negative samples of edges. The performance of the link predictor 548 may be evaluated by an objective function 550. For example, a binary cross entropy may be used as the objective function 550. The parameters of the encoder 528 of the graph neural network may be updated in dependence on the values of the objective function 550 which quantify the performance of the link predictor 548. For example, the parameters may be updated based on backward propagation of a loss quantified by the objective function. The series of steps may be repeated over multiple iterations for one or more profiles included in the training dataset 544. In examples, training the encoder 528 may involve providing a training split within the training graph 522. For example, a fraction of the connections in the graph 522 may be used for training examples and a small fraction may be used for validation. The remaining fraction of the example connections in the graph may be used as the training split within which edges belonging to the positive sample of edges may be predicted in order to train the graph neural network. In this manner, the parameters of the encoder 528 may be updated over the course of training iterations.

A trained graph neural network may be used during inference to generate the set of embeddings required for providing recommendations to a user. Once the graph neural network is trained it may be used as a standalone component in various recommendation tasks. However, since the graph neural network may be trained based on a given scheme 520, updates to the underlying scheme 520 after training may, in general, require retraining the encoder 528 to generate new node embeddings for attributes that may not have been encountered during training. In such cases, the system 100 may be configured to carry out operations including checking, after generating the set of embeddings, the prearranged dataset to determine whether the scheme has been updated. In response to determining that the scheme has been updated to relate the first workforce entity to attributes from an updated set of attributes, the system 100 may be able to processing the profile data using a machine learning model to generate, in dependence on the updated scheme, an updated graph representing information derived from the description of the workforce entity. The updated graph may have an updated set of nodes comprising the first node and one or more updated second nodes each representing a respective attribute from the updated set of attributes and being linked to the first node by an edge relating the workforce entity to the respective attribute. The updated graph may then be processed to generate an updated set of embeddings each representing a respective node of the updated set of nodes, and the user of the system may be provided an updated recommendation in relation to the workforce entity in dependence on the updated set of embeddings. In this manner, the additional attributes introduced within the scheme such as a knowledge graph may be absorbed directly into the training graph without the need to retrain the encoder 528. As a result, embeddings for profile data in the training dataset may be produced simply by re-processing the newly generated training graph by the pretrained encoder 528. In this manner, valuable training time may be saved enabling the recommender system 100 to be computationally efficient. In particular, such savings in computational time may be possible for small incremental changes in the knowledge graph. The inventors have found that using the pretrained encoder 528 for producing embeddings in such scenarios may have similar embedding evaluations as an encoder 528 that may be retrained from scratch. Where larger updates to the knowledge graph are made after training the graph neural network, the encoder 528 may need to be retrained. However, the same training dataset, model architecture and parameter sets may be used in order to reduce the change necessary to achieve a retrained graph neural network.

The above embodiments are to be understood as illustrative examples of the invention. Further embodiments of the invention are envisaged. For example, the amount of information stored in the embeddings generated by the graph neural network may be dependent on the dimensionality of the embeddings. In order to reduce the storage requirements of the graph embeddings, data compression techniques may be used to condense the embedding data into fewer dimensions. For example, compression techniques such as Principal Component Analysis may be used for this purpose. In this manner, the storage efficiency of the recommendary system 100 may be improved. Further, the memory footprint associated with stored embeddings may be reduced by applying binary or integer quantisation to the stored embeddings. In this manner, the retrieval performance of the recommender system 100 may be improved. Furthermore, a framework of repeated experimentation and evaluation may be adopted to identify sources of improving performance, such as identifying most effective embedding sizes.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A system comprising at least one processor and at least one memory, wherein the at least one memory stores instructions for carrying out operations comprising:
receiving profile data comprising a description of a workforce entity;
processing the profile data using a machine learning model to generate, in dependence on a scheme learned from a prearranged dataset and relating the workforce entity and a predefined set of attributes, a graph representing information derived from the description of the workforce entity, the graph having a set of nodes comprising:
a first node representing the workforce entity; and
one or more second nodes each representing a respective attribute from the predefined set of attributes and being linked to the first node by a respective edge relating the workforce entity to the respective attribute;
processing the graph using a graph neural network to generate a set of embeddings each representing a respective node of the set of nodes; and
providing, to a user of the system, a recommendation in relation to the workforce entity in dependence on the set of embeddings.

2. The system of claim 1, wherein the set of embeddings is a first set of embeddings, and wherein providing the recommendation comprises:
deriving a second set of embeddings by combining one or more embeddings from the first set of embeddings, the recommendation being provided in dependence on the second set of embeddings.

3. The system of claim 1, wherein the profile data is first profile data, the workforce entity is a first workforce entity, the description is a first description, the graph is a first graph, the set of nodes is a first set of nodes, the set of embeddings is a first set of embeddings, and the operations comprise:
receiving a context dataset associated with a workforce context, the context dataset including second profile data comprising a second description of a second workforce entity, the scheme relating the second workforce entity to the predefined set of attributes;
processing the context dataset using the machine learning model to obtain a second graph representing information derived from the second description of the second workforce entity, the second graph having a second set of nodes comprising:
a third node representing the second workforce entity; and
one or more fourth nodes each representing a respective attribute from the predefined set of attributes and being linked to the third node by an edge relating the second workforce entity and the respective attribute;
merging the first graph with the second graph to produce a merged graph; and
processing the merged graph using the graph neural network to generate a second set of embeddings each representing a respective node of the merged graph,
wherein the recommendation is provided further in dependence on the second set of embeddings.

4. The system of claim 3, wherein:
the graph neural network is configured to process a subgraph of the merged graph to generate the second set of embeddings, the subgraph comprising:
the first node; and
at least one merged node of the merged graph, the merged node being obtained by performing a matching between a given one of the second nodes and a corresponding one of the fourth nodes.

5. The system of claim 3, wherein providing the recommendation comprises:
determining, using the second set of embeddings, a similarity between the first workforce entity and the second workforce entity; and
providing the recommendation based at least in part on the determined similarity.

6. The system of claim 5, wherein determining the similarity comprises:
obtaining a first embedding in dependence on the second set of embeddings, the first embedding being associated with the first workforce entity;
obtaining a second embedding in dependence on the second set of embeddings, the second embedding being associated with the second workforce entity; and
determining the similarity using the first embedding and the second embedding.

7. The system of claim 5, wherein:
the second set of embeddings comprises a plurality of embeddings associated with a plurality of second nodes that together represent a first attribute from the predefined set of attributes; and
the first embedding is obtained by combining embeddings from the plurality of embeddings that are associated with second nodes linked to the first node.

8. The system of claim 7, wherein each embedding of the second set of embeddings is representable by a respective vector, the first embedding is represented by a first vector, and each component of the first vector is obtained by selecting a maximum of respective components of a second vector and a third vector, the second vector and the third vector representing embeddings from the second set of embeddings.

9. The system of claim 5, wherein providing the recommendation further comprises:
identifying, from the second set of embeddings, an auxiliary embedding associated with second nodes representing a second attribute from the predefined set of attributes;
determining an auxiliary value based at least in part on the auxiliary embedding,
wherein the recommendation is provided in dependence on the auxiliary value.

10. The system of claim 1, wherein the scheme is represented by a knowledge graph associated with a workforce context, the knowledge graph comprising:
a first set of data objects representing entities in the workforce context; and
a second set of data objects representing attributes from the predefined set of attributes,
wherein each data object of the first set of data objects shares a directional edge with a respective data object of the second set of data objects, the edge denoting a respective relationship between the data object in the first set of data objects and the respective data object of the second set of data objects.

11. The system of claim 1, wherein the operations comprise:
checking, after generating the set of embeddings, the prearranged dataset to determine whether the scheme has been updated; and
in response to determining that the scheme has been updated to relate the first workforce entity to attributes from an updated set of attributes:
processing the profile data using a machine learning model to generate, in dependence on the updated scheme, an updated graph representing information derived from the description of the workforce entity, the updated graph having an updated set of nodes comprising:
the first node;
one or more updated second nodes each representing a respective attribute from the updated set of attributes and being linked to the first node by an edge relating the workforce entity to the respective attribute;
processing the updated graph using the graph neural network to generate an updated set of embeddings each representing a respective node of the updated set of nodes; and
providing, to the user of the system, an updated recommendation in relation to the workforce entity in dependence on the updated set of embeddings.

12. The system of claim 1, wherein the description comprises a natural language description, and the machine learning model comprises a language model.

13. The system of claim 11, wherein:
the information derived from the description of the workforce entity is represented by a set of features associated with the set of nodes;
processing the profile data comprises processing, using the language model, the description to generate the set of features, each feature representing a textual label for the respective node; and
the language model is prompted in dependence on the scheme to generate the textual labels.

14. The system of claim 12, wherein:
the machine learning model is a first machine learning model;
each feature of the set of features represents a text embedding for the respective node, a given text embedding being obtained by processing the textual label for the corresponding node using a second machine learning model; and
the graph neural network is configured to process the set of text embeddings corresponding to the set of nodes to generate the set of embeddings.

15. The system of claim 1, wherein the set of nodes includes one or more context nodes each sharing edges with one or more second nodes, wherein processing the graph using the graph neural network comprises processing the one or more context nodes, the set of embeddings comprising embeddings representing the one or more context nodes.

16. The system of claim 14, wherein the one or more context nodes each share an edge with the first node, and wherein processing the profile data using the machine learning model comprises:
processing the profile data using the machine learning model to generate the second nodes and the one or more context nodes with associated output data; and
processing output data associated with the context nodes to generate edges between the one or more context nodes and the second nodes.

17. The system of claim 1, wherein the workforce entity is a first workforce entity, the description is a first description, the graph is a first graph, the set of nodes is a first set of nodes, the profile data is a first profile data included in a training dataset, the training dataset includes second profile data comprising a second description of a second workforce entity, the scheme relates the second workforce entity to the predefined set of attributes, and the operations comprise:
receiving the training dataset;
processing the training dataset using the machine learning model to generate, in dependence on the scheme, a training graph representing information derived from the first description of the first workforce entity and the second description of the second workforce entity, the training graph including a set of training nodes each representing either a workforce entity or an attribute from the predefined set of attributes; and
performing, to train the graph neural network, over one or more iterations:
selecting a training node from the set of training nodes;
identifying an existing set of edges comprising edges including the training node from the training graph;
generating a virtual set of edges comprising edges including the training node from a complement graph of the training graph;
processing a subgraph of the training graph using the graph neural network to generate a set of training embeddings, the subgraph comprising at least one edge selected from the existing set of edges and at least one edge selected from the virtual set of edges; and
processing, using a link predictor, the generated set of training embeddings to identify, for each edge in the subgraph, whether the edge was selected from the existing set of edges or from the virtual set of edges; and
updating parameters of the graph neural network in dependence on an objective function that evaluates performance of the predictor.

18. The system of claim 1, wherein the workforce entity is a candidate for a job, and wherein the predefined set of attributes includes at least one of:
a skill of the candidate;
a qualification of the candidate;
a role of the candidate; or
an employer of the candidate.

19. A computer-implemented method comprising:
receiving profile data comprising a description of a workforce entity;
processing the profile data using a machine learning model to generate, in dependence on a scheme learned from a prearranged dataset and relating the workforce entity and a predefined set of attributes, a graph representing information derived from the description of the workforce entity, the graph having a set of nodes comprising:
a first node representing the workforce entity; and
one or more second nodes each representing a respective attribute from the predefined set of attributes and being linked to the first node by an edge relating the workforce entity to the respective attribute;
processing the graph using a graph neural network to generate a set of embeddings each representing a respective node of the set of nodes; and
providing, to a user, a recommendation in relation to the workforce entity in dependence on the set of embeddings.

20. One or more non-transitory storage media comprising machine-readable instructions which, when executed by a computer, cause the computer to carry out operations comprising:
receiving profile data comprising a description of a workforce entity;
processing the profile data using a machine learning model to generate, in dependence on a scheme learned from a prearranged dataset and relating the workforce entity and a predefined set of attributes, a graph representing information derived from the description of the workforce entity, the graph having a set of nodes comprising:
a first node representing the workforce entity; and
one or more second nodes each representing a respective attribute from the predefined set of attributes and being linked to the first node by a respective edge relating the workforce entity to the respective attribute;
processing the graph using a graph neural network to generate a set of embeddings each representing a respective node of the set of nodes; and
providing, to a user of the computer, a recommendation in relation to the workforce entity in dependence on the set of embeddings.
